(19) United States
(12) Patent Application Publication
(10) Pub. No.: US 2009/0148213 A1
(43) Pub. Date: Jun. 11, 2009

(54) IMAGE FORMING APPARATUS

(76) Inventor: Junya MASUDA, Ikoma-gun (JP)

Correspondence Address: MARK D. SARALINO ( SHARP );RENNER, OTTO, BOISSELLE & SKLAR, LLP, 1621 EUCLID AVENUE, 19TH FLOOR, CLEVELAND, OH, 44115, US

(21) Appl. No.: 12/272,013

(22) Filed: Nov. 17, 2008

(30) Foreign Application Priority Data
Dec. 7, 2007 (JP) 2007-316586

(51) Int. Cl. G03G 15/00

(52) U.S. Cl. 399/401

(57) ABSTRACT

An image forming apparatus includes: an image forming section on a main feed path for performing image formation on a first recording medium to be subjected to single-side printing and on a second recording medium to be subjected to double-side printing; and an output section for delivering these recording media. The apparatus has first to third positions between the apparatus and the output section at each of which a feed path branches off the main feed path. The apparatus further includes: a subsidiary feed path extending from the first position and joining the main feed path at an entrance of the main feed path; a first switchback feed path formed in a place extending from the second position for turning the second recording medium upside down; and a second switchback feed path formed in a place extending from the third position for turning the first recording medium upside down.

### CROSS REFERENCE

This Nonprovisional application claims priority under 35 U.S.C. §119(a) on Patent Application No. 2007-316586 filed in Japan on Dec. 7, 2007, the entire contents of which are hereby incorporated by reference.

### BACKGROUND OF THE INVENTION

The present invention relates to an image forming apparatus configured to deliver a recording medium in an overturned state after having been subjected to image forming processing.

Among image forming apparatuses such as digital copiers, there are image forming apparatuses of the type configured to turn an image bearing side of each recording medium down after image forming processing in successive image formation on plural recording media.

Conventionally, a switchback feed path is known as a mechanism for overturning a recording medium having been subjected to image forming processing (see Japanese Patent Laid-Open Publication No. JP-H09-301597 for example). Such a switchback feed path is provided with a feed roller for feeding recording media. An image forming apparatus of the aforementioned type has a single switchback feed path, feeds a single image recording medium having been subjected to image forming processing into the switchback feed path, feeds the recording medium backwardly in the switchback feed path, and then delivers the recording medium toward a sheet output section. Thereafter, a succeeding recording medium is fed into the switchback feed path. In this way, the aforementioned image forming apparatus feeds recording media one by one by way of the switchback feed path.

To meet the demand existing in recent years for increase in image formation speed, an image forming apparatus having such a switchback feed path is provided with a higher speed motor for rotating the feed roller of the switchback feed path.

However, the increase in the speed of such a motor is limited. With only the increase in motor speed relied upon, it is difficult to smoothly turn individual recording media upside down after image forming processing.

When single-side printing and double-side printing are performed mixingly, passage of recording media one by one via the switchback feed path results in poor feeding efficiency. From this point of view, there is also a limitation on an increase in the rate of delivery of recording media per unit time relying only upon the increase in motor speed when single-side printing and double-side printing are performed mixingly.

An object of the present invention is to provide an image forming apparatus which is capable of increasing the rate of delivery of recording media per unit time even when recording media intended for single-side printing and those intended for double-side printing are mixed in overturning recording media after image forming processing.

### SUMMARY OF THE INVENTION

An image forming apparatus according to the present invention includes an image forming section, a output section, a main feed path, a subsidiary feed path, a first switchback feed path, a second switchback feed path, and a control section.

The image forming section is configured to perform image forming processing on recording media. Such recording media include a first recording medium to be subjected to single-side printing, and a second recording medium to be subjected to double-side printing. The output section is configured to store therein recording media having been subjected to image formation thereon. The main feed path forms a feed path reaching the output section through the image forming section. The subsidiary feed path forms a feed path extending from a first position between the image forming section and the output section at which the subsidiary feed path branches off the main feed path and reaching (returning to) an entrance of the main feed path. That is, the subsidiary feed path joins the main feed path at the entrance of the main feed path (at a location upstream of the image forming section). The first switchback feed path is formed in a place extending from a second position between the image forming section and the output section at which the first switchback feed path branches off the main feed path. The first switchback feed path is configured to turn the recording medium for double-side printing upside down. The second switchback feed path is formed in a place extending from a third position between the image forming section and the output section at which the second switchback feed path branches off the main feed path. The second switchback feed path is configured to turn the recording medium for single-side printing upside down.

The control section is configured to control feeding of the first and second recording media having been subjected to image formation thereon by the image forming section to any one of the output section, the subsidiary feed path, the first switchback feed path and the second switchback feed path.

The image forming apparatus according to the present invention, which includes the first switchback feed path for turning the second recording medium for double-side printing upside down, and the second switchback feed path for turning the first recording medium for double-side printing upside down, is capable of increasing the rate of delivery of recording media per unit time by reducing the spacing between adjacent recording media when requests for both of single-side printing and double-side printing are made mixingly.

The foregoing and other features and attendant advantages of the present invention will become more apparent from the reading of the following detailed description of the invention in conjunction with the accompanying drawings.

### BRIEF DESCRIPTION OF THE DRAWINGS

FIG. 1 is a view showing a configuration of an image forming apparatus according to an embodiment of the present invention;

FIGS. 2A to 2C are views each showing a state of a first stage in subjecting successive recording sheets to printing and feeding in the image forming apparatus according to the embodiment of the present invention;

FIGS. 3A to 3C are views each showing a state of a second stage in subjecting successive recording sheets to printing and feeding in the image forming apparatus according to the embodiment of the present invention;

FIGS. 4A to 4C are views each showing a state of a third stage in subjecting successive recording sheets to printing and feeding in the image forming apparatus according to the embodiment of the present invention;

FIGS. 5A to 5C are views each showing a state of a fourth stage in subjecting successive recording sheets to printing and feeding in the image forming apparatus according to the embodiment of the present invention;

FIG. 6 is a block diagram showing a partial configuration of a control section 50 included in the image forming apparatus according to the embodiment of the present invention;

FIG. 7 is a flowchart showing a procedure for controlling feeding of recording sheets to a destination in response to a printing request made to the image forming apparatus according to the embodiment of the present invention; and

FIG. 8 is a flowchart showing a procedure for delivering a recording sheet stopped in a feed path in the image forming apparatus according to the embodiment of the present invention.

### DETAILED DESCRIPTION OF THE INVENTION

Hereinafter, an image forming apparatus according to the best mode of the present invention will be described in detail with reference to the drawings.

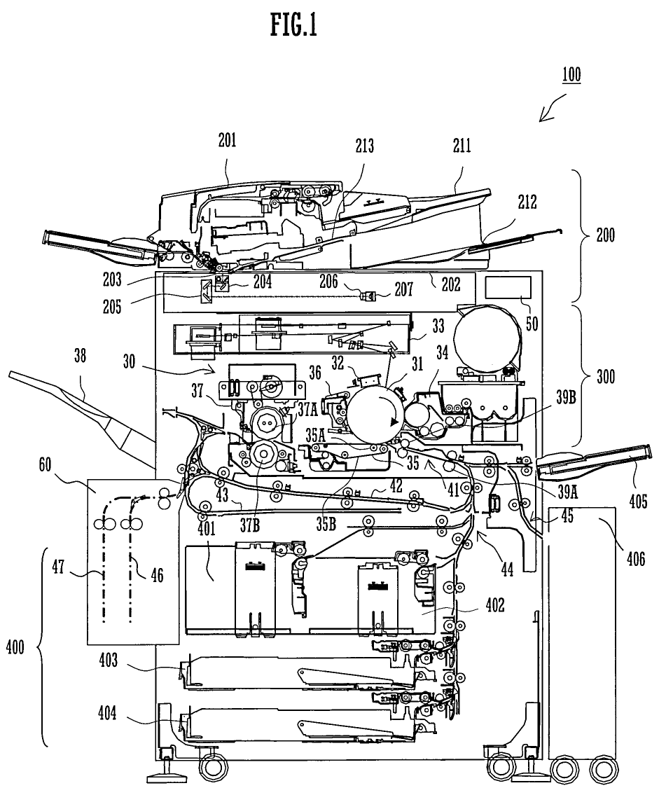

FIG. 1 is a view showing a configuration of an image forming apparatus according to an embodiment of the present invention. The image forming apparatus 100 includes an image reading unit 200, an image recording unit 300, a sheet feeding unit 400, and a control section 50.

The image reading unit 200 includes an automatic document feeder (ADF) 201, a first document platen 202, a second document platen 203, a first mirror base 204, a second mirror base 205, a lens 206, and a solid-state image sensor (CCD: Charge Coupled Device) 207.

The ADF 201 defines a document feed path 213 extending from a document tray 211 to a delivery tray 212 via the second document platen 203. The ADF 201 feeds document sheets one by one into the document feed path 213. The ADF 201 is pivotable about its the rear side to cover the top surface of the first document platen 202 openably. When the top surface of the first document platen 202 is exposed by turning the ADF 201 so as to move the front side thereof upwardly, a document sheet is allowed to be placed on the first document platen 202 manually.

The first and second document platens 202 and 203 each comprise a hard glass plate.

The first mirror base 204 and the second mirror base 205 are horizontally movable below the first and second document platens 202 and 203. The traveling speed of the second mirror base 205 is ½ as high as that of the first mirror base 204. The first mirror base 204 carries thereon a light source and a first mirror. The second mirror base 205 carries thereon a second mirror and a third mirror.

In reading an image on a document sheet fed by the ADF 201, the first mirror base 204 is at rest below the second document platen 203. Light from the light source is directed toward the image bearing side of the document sheet passing over the second document platen 203, and reflected light from the image bearing side of the document sheet is reflected by the first mirror toward the second mirror base 205.

In reading an image on a document sheet placed on the first document platen 202, the first and second mirror bases 204 and 205 move horizontally below the first document platen 202. Light from the light source is directed toward the image bearing side of the document sheet placed on the first document platen 202, and reflected light from the image bearing side of the document sheet is reflected by the first mirror toward the second mirror base 205.

Reflected light from the image bearing side of a document sheet passes along an optical path length made constant irrespective of whether or not the ADF 201 is used, and becomes incident on the CCD 207 through the lens 206 by means of the second and third mirrors.

The CCD 207 outputs electric signals in accordance with light quantities of light reflected by the image bearing side of a document sheet. Such electric signals are inputted as image data to the image recording unit 300 via the control section 50.

The image recording unit 300 includes a photosensitive drum 31, an electrostatic charger 32, an exposure device 33, a developing device 34, a transfer device 35, a cleaning unit 36, and a fixing device 37. An image forming section 30 is constructed of the photosensitive drum 31, electrostatic charger 32, exposure device 33, developing device 34, transfer device 35, cleaning unit 36 and fixing device 37.

The photosensitive drum 31 has a photosensitive layer over its periphery and rotates in a direction indicated by arrow. The electrostatic charger 32 electrostatically charges the periphery of the photosensitive drum 31 at a predetermined uniform potential. The electrostatic charger 32 may be of a non-contact type employing a charger or of a contact type employing a roller or a brush.

The exposure device 33, which is an LSU (Laser Scanning Unit) for example, axially scans the periphery of the photosensitive drum 31 with laser light modulated according to the image data by way of a polygonal mirror. Thus, an electrostatic latent image is formed on the periphery of the photosensitive drum 31 by the photoconductive action of the photosensitive layer. Instead of the LSU, it is possible to use an exposure device having an array of light-emitting devices such as ELs or LEDs.

The developing device 34 supplies toner (i.e., developer) onto the periphery of the photosensitive drum 31 to turn the electrostatic latent image into a visible toner image (i.e., developer image).

The transfer device 35 includes a transfer roller 35A and a transfer belt 35B. The transfer belt 35B is entrained around plural rollers to form a loop below the photosensitive drum 31. The transfer belt 35B has a resistivity of about 1×10⁹ to about 1×10¹³ Ω·cm. The transfer roller 35A pressed against the photosensitive drum 31 across the transfer belt 35B is located internally of the loop-shaped track of movement of the transfer belt 35B. A predetermined transfer voltage is applied to the transfer roller 35A to transfer the toner image carried on the photosensitive drum 31 to a recording sheet passing between the transfer belt 35B and the photosensitive drum 31. Such a recording sheet is an example of a recording medium.

The cleaning unit 36 collects residual toner which remains on the periphery of the photosensitive drum 31 after the toner image has been transferred to the recording sheet.

The fixing device 37 includes a heating roller 37A and a press roller 37B. The heating roller 37A is heated by an internal heat source to a temperature that allows the toner to fuse. The press roller 37B is pressed against the heating roller 37A with a predetermined pressure. The fixing device 37 heats and pressurizes the recording sheet passing between the heating roller 37A and the press roller 37B, thereby firmly fixing the toner image to the recording sheet. The recording sheet having passed through the fixing device 37 is delivered to a copy receiving tray 38. The copy receiving tray 38 is equivalent to the output section defined by the present invention.

The sheet feeding unit 400 includes sheet feed cassettes 401 to 404 and a manual feed tray 405. The sheet feed cassettes 401 to 404 each contain plural recording sheets of the same size. The manual feed tray 405 is adapted to receive recording sheets having a size or a paper quality for use with a low frequency.

The sheet feeding unit 400 feeds recording sheets one by one from any one of the sheet feed cassettes 401 to 404 or the manual feed tray 405. The image forming apparatus 100 includes a main feed path 41, a subsidiary feed path 42, a first switchback feed path 43, sheet feed paths 44 and 45, and second switchback feed paths 46 and 47.

The main feed path 41 forms a feed path reaching the copy receiving tray 38 (i.e., output section) through the image forming section 30.

The subsidiary feed path 42 forms a feed path extending from a first position between the image forming section 30 and the copy receiving tray 38 (i.e., output section) at which the subsidiary feed path 42 branches off the main feed path 41 and reaching the entrance of the main-feed path 41 to join the main feed path 41 at a location upstream of the image forming section 30.

The first switchback feed path 43 is formed in a place extending from a second position between the image forming section 30 and the copy receiving tray 38 (i.e., output section) at which the first switchback feed path 43 branches off the main feed path 41. The first switchback feed path 43 turns a recording sheet for double-side printing (i.e., second recording medium) upside down.

The second switchback feed paths 46 and 47 are formed in a place extending from a third position between the image forming section 30 and the copy receiving tray 38 (i.e., output section) at which the second switchback feed paths 46 and 47 branch off the main feed path 41. The second switchback feed paths 46 and 47 each turn a recording sheet for single-side printing (i.e., first recording medium) upside down.

The subsidiary feed path 42 may be used as a switchback feed path for turning a recording sheet for single-side printing (i.e., first recording medium) upside down. By using the subsidiary feed path 42 as the switchback feed path, it is possible to reduce the spacing between adjacent ones of a larger number of recording sheets, thereby to increase the rate of delivery of recording sheets per unit time in volume printing. The second switchback feed paths 46 and 47 are accommodated in an option unit 60. The option unit 60 is made removable from the image forming apparatus 100 toward its sheet output side. The provision of the option unit 60 made removable from the image forming apparatus 100 makes it possible to reduce the size of the image forming apparatus 100 by removing the option unit 60 from the image forming apparatus 100 in low-volume printing, as well as to increase the rate of delivery of recording sheets per unit time by attaching the option unit 60 to the image forming apparatus 100 in high-volume printing. A recording sheet fed from any one of the sheet feed cassettes 401 to 404 is fed to the image forming section 30 through the sheet feed path 44 and the main feed path 41 by means of rollers including a pre-registration roller 39A.

The subsidiary feed path 42 and the first switchback feed path 43 are displaceable between their respective accommodated positions in which these feed paths communicate with the main feed path 41 and their respective exposed positions in which the feed paths drawn out of the main body of the apparatus are exposed to the outside. When one of the subsidiary feed path 42 and the first switchback feed path 43 is in its exposed position, the other feed path and the main feed path 41 are made to cooperate with each other to feed recording sheets therebetween smoothly.

A registration roller 39B is disposed downstream of the pre-registration roller 39A in the sheet feed direction. The leading edge of a recording sheet fed by the pre-registration roller 39A is butted against the registration roller 39B at rest. The registration roller 39B has a rotating shaft extending in directions perpendicular to the sheet feed direction. When the recording sheet is positioned askew, skew correction is made by butting the leading edge of the recording sheet against the registration roller 39B.

The registration roller 39B starts rotating with such timing as to allow the leading edge of the recording sheet to be registered with the leading edge of the toner image formed on the periphery of the photosensitive drum 31, to feed the recording sheet between the photosensitive drum 31 and the transfer belt 35. Thus, the toner image is transferred and fixed to the recording sheet as described above and then the recording sheet is delivered to the copy receiving tray 38.

A large capacity cassette (LCC) 406 may be placed on a lateral side of the image forming apparatus 100 and below the manual feed tray 405. The LCC 406 contains a large number of recording sheets. A recording sheet fed from the LCC 406 is fed to the image forming section 30 through the sheet feed path 45 and the main feed path 41.

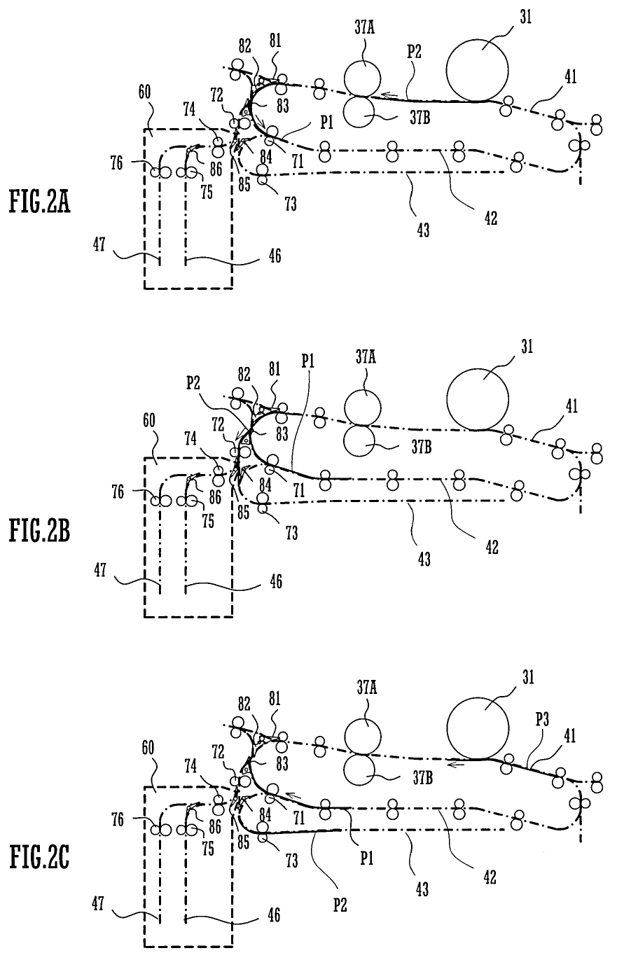

FIGS. 2 to 5 are views showing stages in subjecting successive recording sheets to printing and feeding in the image forming apparatus according to the embodiment of the present invention.

Description is directed to an exemplary case of printing on five recording sheets in which the first, third and fourth recording sheets are intended for single-side printing while the second and fifth recording sheets intended for double-side printing.

When image formation starts, a feed control in the first stage shown in FIGS. 2A to 2C is performed.

As shown in FIG. 2A first, the first recording sheet P1 (for single-side printing) is subjected to image formation on an obverse side thereof by the image forming section 30 and then fed into the subsidiary feed path 42. Subsequently, the second recording sheet P2 (for double-side printing) is subjected to image formation on an obverse side thereof by the image forming section 30 and then fed with a predetermined spacing from the first recording sheet P1.

In this case the first recording sheet P1 (for single-side printing) is fed into the subsidiary feed path 42. By so doing, the second switchback feed paths 46 and 47 can be left vacated. For this reason, when a recording sheet for single-side printing follows the second recording sheet P2 (for double-side printing), the spacing between adjacent recording sheets can be reduced and, hence, the rate of delivery of recording sheets per unit time can be increased.

Subsequently, as shown in FIG. 2B, the first recording sheet P1 (for single-side recording) is stopped when fed into the entrance of the subsidiary feed path 42. The second recording sheet P2 (for double-side printing) is fed into the first switchback feed path 43.

Subsequently, as shown in FIG. 2C, the first recording sheet P1 (for single-side recording) starts being fed in an overturned state. The second recording sheet P2 (for double-side printing) is stopped in the first switchback feed path 43. The third recording sheet P3 (for single-side printing) is subjected to image formation on an obverse side thereof by the image forming section 30.

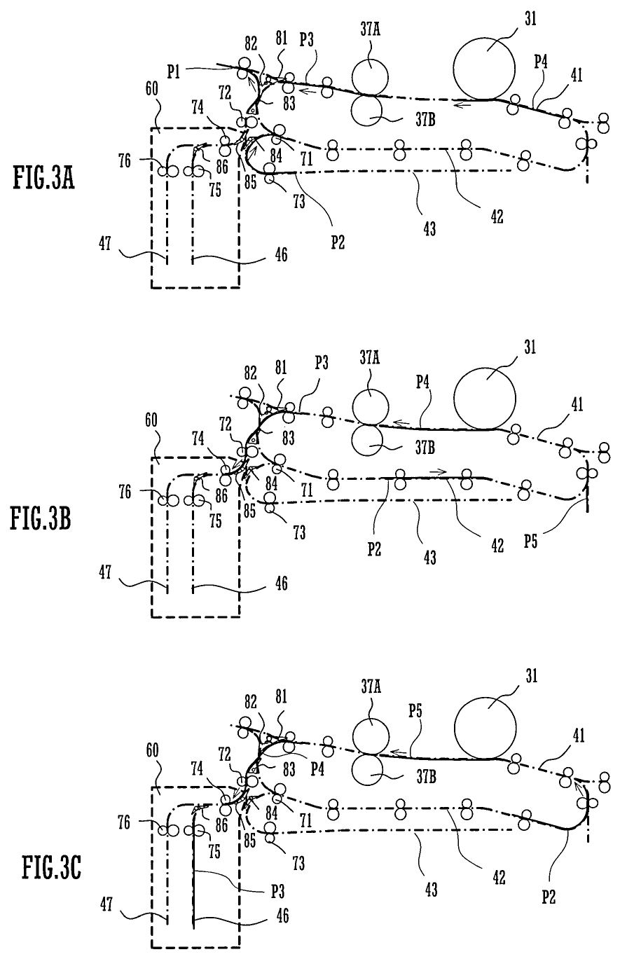

Subsequently, a feed control is performed in the second stage shown in FIGS. 3A to 3C.

As shown in FIG. 3A, the first recording sheet P1 (for single-side printing) is fed toward the copy receiving tray 38. The second recording sheet P2 (for double-side printing) is turned upside down and fed into the subsidiary feed path 42. The third recording sheet P3 (for single-side printing) is fed toward the second switchback feed path 46 so as to replace the first recording sheet P1 (for single-side printing). The fourth recording sheet P4 (for single-side printing) is fed toward the image forming section 30. Here, since the third recording sheet P3 (for single-side printing) is a recording sheet following the second recording sheet P2 (for double-side printing), the third recording sheet P3 (for single-side printing) is fed into the second switchback feed path 46. By so doing, the subsidiary feed path 42 can be left vacated and, hence, the recording sheet for double-side printing in the first switchback feed path 43 can be fed in an overturned state smoothly.

Subsequently, as shown in FIG. 3B, the second recording sheet P2 (for double-side printing) is fed through the subsidiary feed path 42 toward the main feed path 41. The third recording sheet P3 (for single-side printing) is fed toward the second switchback feed path 46. The fourth recording sheet P4 (for single-side printing) is subjected to image formation on an obverse side thereof by the image forming section 30. The fifth recording sheet P5 (for double-side printing) is fed toward the main feed path 41.

Subsequently, as shown in FIG. 3C, the second recording sheet P2 (for double-side printing) is fed from the subsidiary feed path 42 toward the main feed path 41. The third recording sheet P3 (for single-side printing) is stopped in the second switchback feed path 46. The fourth recording sheet P4 (for single-side printing) is fed toward the second switchback feed path 47. The fifth recording sheet P5 (for double-side printing) is subjected to image formation on an obverse side thereof by the image forming section 30.

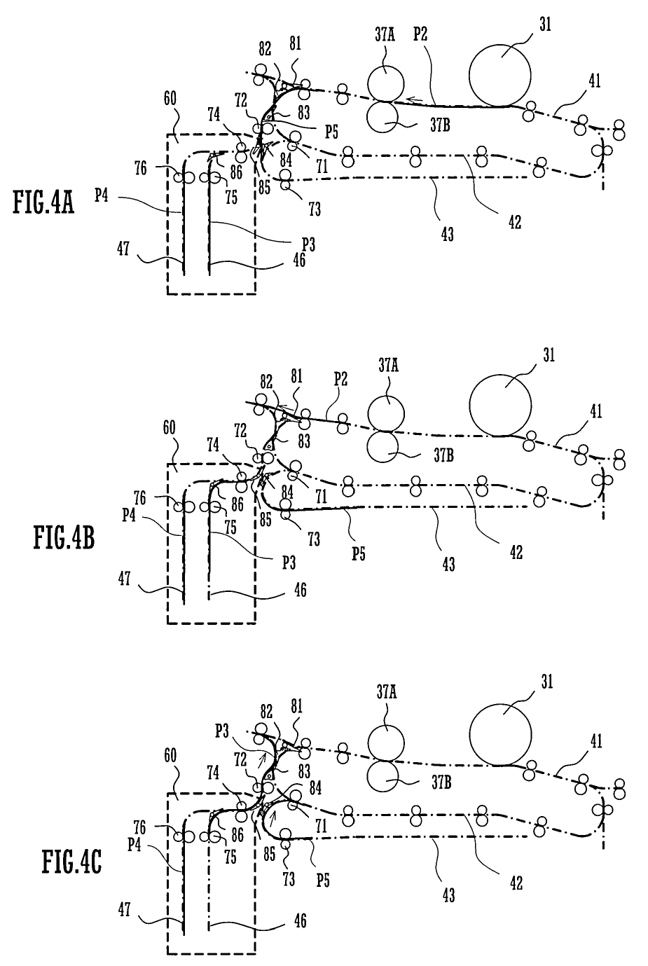

Subsequently, a feed control is performed in the third stage shown in FIGS. 4A to 4C.

As shown in FIG. 4A, the second recording sheet P2 (for double-side printing) is subjected to image formation on the reverse side thereof by the image forming section 30. The third recording sheet P3 (for single-side printing) remains stopped in the second switchback feed path 46. The fourth recording sheet P4 (for single-side printing) is stopped in the second feedback path 47. The fifth recording sheet P5 (for double-side printing) is fed toward the first switchback feed path 43.

Subsequently, as shown in FIG. 4B, the second recording sheet P2 (for double-side printing) is fed toward the copy receiving tray 38. The third recording sheet P3 (for single-side printing) starts being fed in an overturned state so as to replace the fifth recording sheet P5 (for double-side printing). The fourth recording sheet P4 (for single-side printing) remains stopped in the second switchback feed path 47. The fifth recording sheet P5 (for double-side printing) is stopped in the first switchback feed path 43.

Subsequently, as shown in FIG. 4C, the third recording sheet P3 (for single-side printing) is fed toward the copy receiving tray 38. The fourth recording sheet P4 (for single-side printing) remains stopped in the second switchback feed path 47. The fifth recording sheet P5 (for double-side printing) is turned upside down and fed toward the subsidiary feed path 42.

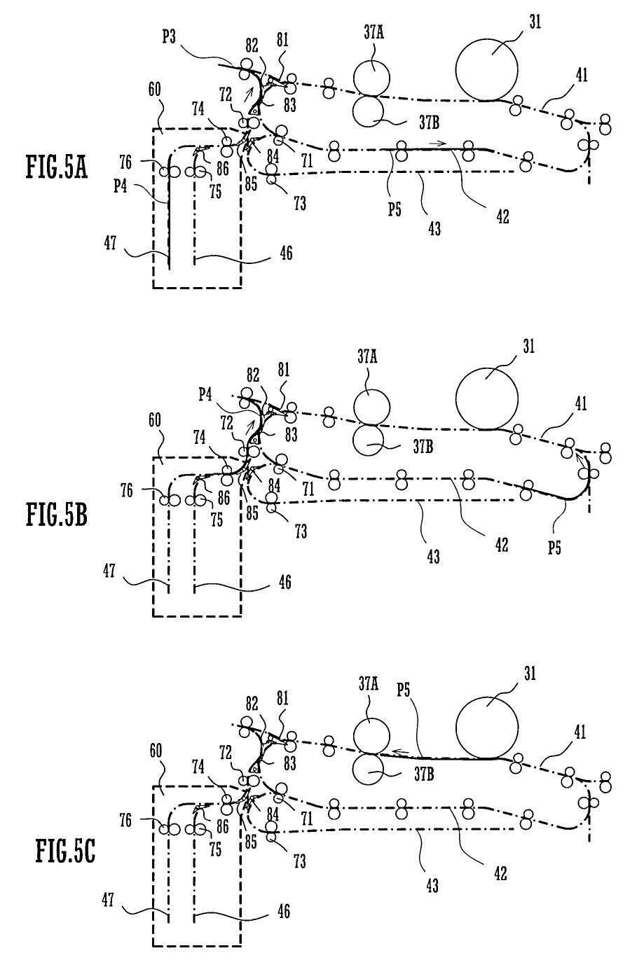

Subsequently, as shown in FIG. 5A, the third recording sheet P3 is fed toward the copy receiving tray 38. The fourth recording sheet P4 remains stopped in the second switchback feed path 47. The fifth recording sheet P5 is fed through the subsidiary feed path 42.

Subsequently, a feed control is performed in the fourth stage shown in FIGS. 5A to 5C.

As shown in FIG. 5A, the fourth recording sheet P4 (for single-side printing) is fed toward the copy receiving tray 38. The fifth recording sheet P5 (for double-side printing) is fed from the subsidiary feed path 42 toward the main feed path 41.

Subsequently, as shown in FIG. 5C, the fifth recording sheet P5 (for double-side printing) is subjected to image formation on the reverse side thereof by the image forming section 30.

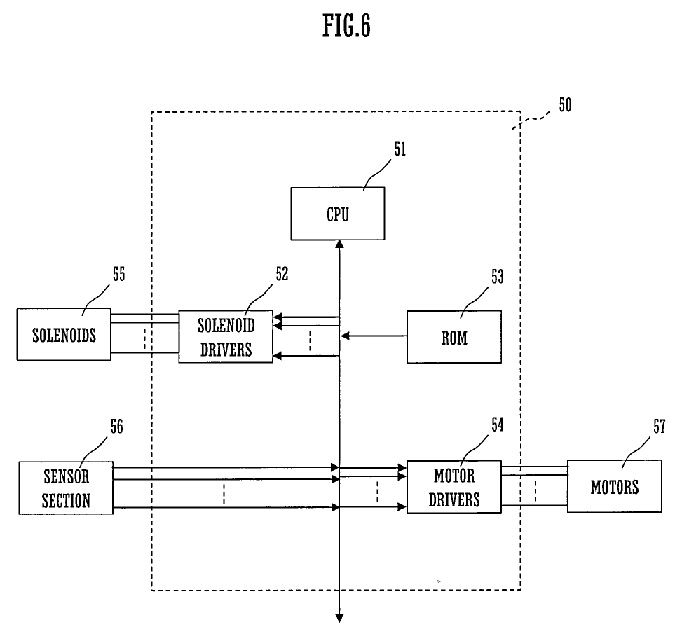

FIG. 6 is a block diagram showing a partial configuration of the control section 50 included in the image forming apparatus according to the embodiment of the present invention.

The control section 50 includes a CPU 51 having ROM 53 and connected to solenoid drivers 52, to motor drivers 54 and to a sensor section 56.

The sensor section 56 includes plural detection sensors at least one of which is provided on each of the main feed path 41, subsidiary feed path 42, first switchback feed path 43 and second switchback feed paths 46 and 47. The plural sensors are placed at different predetermined locations on the feed paths 41, 42, 43, 46 and 47. When each of the sensors is turned on, the sensor outputs a detection signal indicative of detection of a recording sheet to the CPU 51.

When any one of the detection sensors starts inputting the detection signal to the CPU 51, the CPU 51 judges that the detection sensor of concern has detected the leading edge of a recording sheet. If continuous inputting of the detection signal from the sensor is terminated within a predetermined time period from the start of inputting, the CPU 51 judges that the trailing edge of the recording sheet has passed the location of the sensor of concern. Alternatively, if continuous inputting of the detection signal from the sensor lasts for more than the predetermined time period with unexpected timing, the CPU 51 judges that a sheet jam occurs at the location of the sensor of concern.

According to a program previously stored in the ROM 52, the CPU 51 outputs driving data to the solenoid drivers 52 and the motor drivers 54 by referencing the detection signal inputted thereto from the sensor section 56.

The solenoid drivers 52 are connected to respective solenoids 55. The solenoid drivers 52 drive the solenoids 55 based on the driving data outputted from the CPU 51.

The solenoids 55 drive gates 81 to 86.

The motor drivers 54 are connected to respective motors 57. The motor drivers 54 drive the motors 57 based on the driving data outputted from the CPU 51.

The motors 57 rotate the photosensitive drum 31, fixing device 37, feed rollers 71 to 76, and the like.

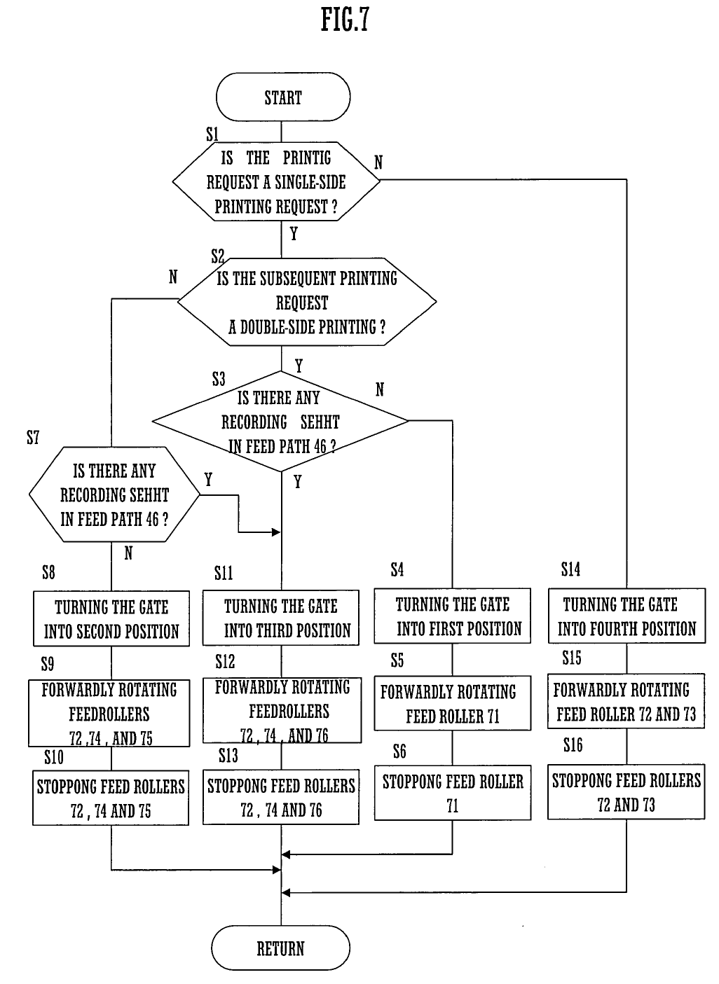

FIG. 7 is a flowchart showing a procedure for controlling feeding of recording sheets to a destination in response to a printing request made to the image forming apparatus according to the embodiment of the present invention.

Upon a printing request, judgment is made as to whether or not the printing request is a single-side printing request (step S1). If the printing request is judged as the single-side printing request, judgment is made as to whether or not a subsequent printing request is a double-side printing request (step S2). If the subsequent printing request is judged as the double-side printing request, judgment is made as to whether or not any recording sheet is present in the second switchback feed path 46 (step S3). If it is judged that any recording sheet is not present, a gate is set into a first position (step S4). The first position of the gate is a position that enables a recording sheet to be fed to the subsidiary feed path 42. Subsequently, the feed roller 71 is rotated forwardly to feed the recording sheet to the subsidiary feed path 42 (step S5) and then stopped to stop feeding the recording sheet (step S6).

If it is judged in step S2 that the printing request is not the double-side printing request, judgment is made as to whether or not any recording sheet is present in the second switchback feed path 46 (step S7). If it is judged that any recording sheet is not present, the gate is set into a second position (step S8). The second position of the gate is a position that enables a recording sheet to be fed to the second switchback feed path 46. Subsequently, the feed rollers 72, 74 and 75 are rotated forwardly to feed the recording sheet to the second switchback feed path 46 (step S9) and then stopped to stop feeding the recording sheet (step S10).

If it is judged in step S3 or S7 that a recording sheet is present in the second switchback feed path 46, the gate is set into a third position (step S11). The third position of the gate is a position that enables a recording sheet to be fed to the second switchback feed path 47. Subsequently, the feed rollers 72, 74 and 76 are rotated forwardly to feed the recording sheet to the second switchback feed path 47 (step S12) and then stopped to stop feeding the recording sheet (step S13).

If it is judged in step S1 that the printing request is not the single-side printing request, the gate is set into a fourth position (step S14). The fourth position of the gate is a position that enables a recording sheet to be fed to the first switchback feed path 43. Subsequently, the feed rollers 72 and 73 are rotated forwardly to feed the recording sheet to the first switchback feed path 43 (step S15) and then stopped to stop feeding the recording sheet (step S16).

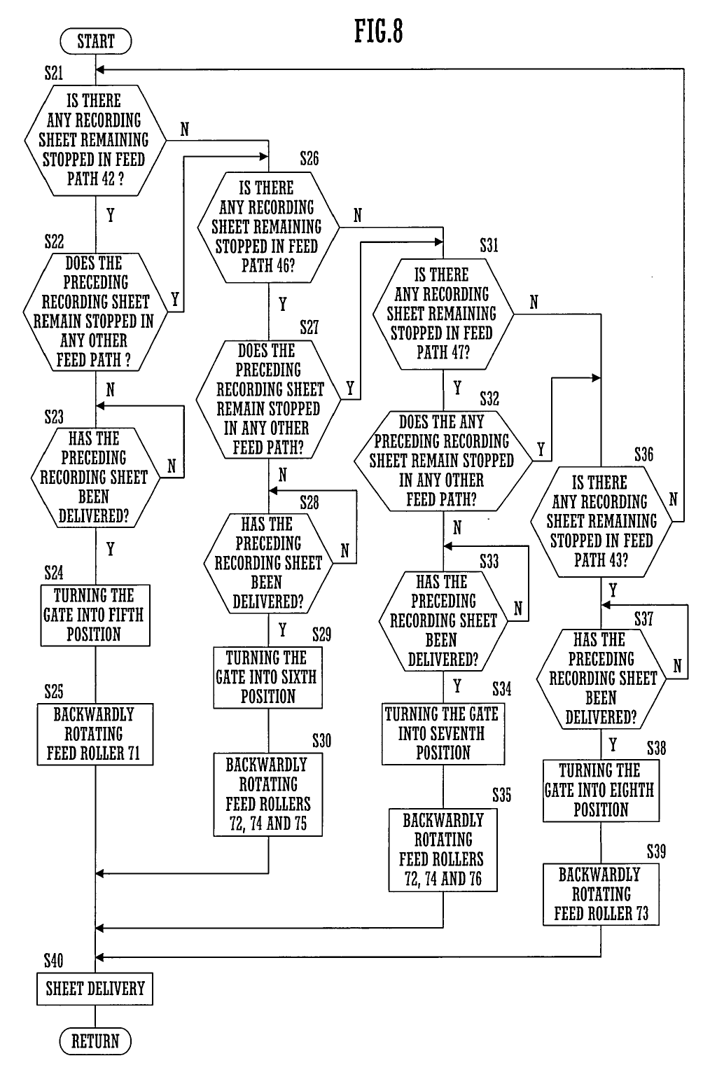

FIG. 8 is a flowchart showing a procedure for delivering a recording sheet stopped in a feed path in the image forming apparatus according to the embodiment of the present invention.

Initially, judgment is made as to whether or not any recording sheet remains stopped in the subsidiary feed path 42 (step S21). If it is judged that a recording sheet remains stopped therein, judgment is made as to whether or not the recording sheet that precedes this recording sheet remains stopped in any other feed path (step S22). If it is judged that the preceding recording sheet does not remain stopped in any other feed path, judgment is made as to whether or not the preceding recording sheet has been delivered (step S23). If it is judged that the preceding recording sheet has been delivered, the gate is set into a fifth position (step S24). The fifth position of the gate is a position that enables a recording sheet to be fed from the subsidiary feed path 42 to the copy receiving tray 38. Subsequently, the feed roller 71 is rotated backwardly (step S25) to feed the recording sheet present in the subsidiary feed path 42 to the copy receiving tray 38 (step S40).

If it is judged in step S21 that no recording sheet remains stopped in the subsidiary feed path 42 or if it is judged in step S22 that the preceding sheet remains stopped in any other feed path, judgment is made as to whether or not any recording sheet remains stopped in the second switchback feed path 46 (step S26). If it is judged that a recording sheet remains stopped in the second switchback feed path 46, judgment is made as to whether or not the recording sheet that precedes this recording sheet remains stopped in any other feed path (step S27). If it is judged that the preceding recording sheet does not remain stopped in any other feed path, judgment is made as to whether or not the preceding recording sheet has been delivered (step S28). If it is judged that the preceding recording sheet has been delivered, the gate is set into a sixth position (step S29). The sixth position of the gate is a position that enables a recording sheet to be fed from the second switchback feed path 46 to the copy receiving tray 38. Subsequently, the feed rollers 72, 74 and 75 are rotated backwardly (step S30) to feed the recording sheet present in the second switchback feed path 46 to the copy receiving tray 38 (step S40).

If it is judged in step S26 that no recording sheet remains stopped in the second switchback feed path 46 or if it is judged in step S27 that the preceding sheet remains stopped in any other feed path, judgment is made as to whether or not any recording sheet remains stopped in the second switchback feed path 47 (step S31). If it is judged that a recording sheet remains stopped in the second switchback feed path 47, judgment is made as to whether or not the recording sheet that precedes this recording sheet remains stopped in any other feed path (step S32). If it is judged that the preceding recording sheet does not remain stopped in any other feed path, judgment is made as to whether or not the preceding recording sheet has been delivered (step S33). If it is judged that the preceding recording sheet has been delivered, the gate is set into a seventh position (step S34). The seventh position of the gate is a position that enables a recording sheet to be fed from the second switchback feed path 47 to the copy receiving tray 38. Subsequently, the feed rollers 72, 74 and 76 are rotated backwardly (step S35) to feed the recording sheet present in the second switchback feed path 47 to the copy receiving tray 38 (step S40).

If it is judged in step S31 that no recording sheet remains stopped in the second switchback feed path 47 or if it is judged in step S32 that the preceding sheet remains stopped in any other feed path, judgment is made as to whether or not any recording sheet remains stopped in the first switchback feed path 43 (step S36). If it is judged that a recording sheet remains stopped in the first switchback feed path 43, judgment is made as to whether or not the preceding recording sheet has been delivered (step S37). If it is judged that the preceding recording sheet has been delivered, the gate is set into an eighth position (step S38). The eighth position of the gate is a position that enables a recording sheet to be fed from the first switchback feed path 43 to the copy receiving tray 38. Subsequently, the feed roller 73 is rotated backwardly (step S39) to feed the recording sheet to the copy receiving tray 38 by passing the recording sheet through the subsidiary feed path 42 and the main feed path 41 sequentially (step S40).

By feeding recording sheets in this way, it is possible to deliver the recording sheets in the order of pages and increase the rate of delivery of recording sheets per unit time by reducing the spacing between adjacent recording sheets when requests for both of single-side printing and double-side printing are made mixingly.

While the foregoing embodiment has a single switchback feed path as the first switchback feed path and two switchback feed paths as the second switchback feed path, each of the first and second switchback feed paths may be increased in number. With increasing number of switchback feed paths, the spacing between adjacent ones of a larger number of recording sheets can be reduced, thus leading to a higher rate of delivery of recording sheets per unit time in volume printing.

While the foregoing embodiment has been applied to the case of reducing the spacing between adjacent recording sheets when requests for both of single-side printing and double-side printing are made mixingly, the foregoing embodiment is not limited to this case. By applying the foregoing embodiment to the case of single-side printing only or double-side printing only, it is possible to reduce the spacing between adjacent recording sheets, thereby to increase the rate of delivery of recording sheets per unit time.

The foregoing embodiment is illustrative in all points and should not be construed to limit the present invention. The scope of the present invention is defined not by the foregoing embodiment but by the following claims. Further, the scope of the present invention is intended to include all modifications within the meanings and scopes of claims and equivalents.

What is claimed is:

1. An image forming apparatus comprising:
an image forming section configured to perform image forming processing on a first recording medium to be subjected to single-side printing and on a second recording medium to be subjected to double-side printing;
an output section configured to store therein the first and second recording media having been subjected to image formation thereon by the image forming section;
a main feed path forming a feed path reaching the output section through the image forming section;
a subsidiary feed path forming a feed path extending from a first position between the image forming section and the output section at which the subsidiary feed path branches off the main feed path and reaching an entrance of the main feed path to join the main feed path at a location upstream of the image forming section;
a first switchback feed path formed in a place extending from a second position between the image forming section and the output section at which the first switchback feed path branches off the main feed path, the first switchback feed path being configured to turn the second recording medium upside down;
a second switchback feed path formed in a place extending from a third position between the image forming section and the output section at which the second switchback feed path branches off the main feed path, the second switchback feed path being configured to turn the first recording medium upside down; and
a control section configured to control feeding of the first and second recording media having been subjected to image formation thereon by the image forming section to any one of the output section, the subsidiary feed path, the first switchback feed path and the second switchback feed path.

2. The image forming apparatus according to claim 1, wherein the control section feeds the first recording medium to the subsidiary feed path to turn the first recording medium upside down.

3. The image forming apparatus according to claim 1, wherein the control section feeds the first recording medium to the subsidiary feed path to turn the first recording medium upside down when the second recording medium is fed to follow the first recording medium.

4. The image forming apparatus according to claim 1, wherein the control section feeds the first recording medium to the second switchback feed path to turn the first recording medium upside down when the second recording medium is fed to precede the first recording medium.

5. The image forming apparatus according to claim 1, wherein at least one of the first switchback feed path and the second switchback feed path comprises a plurality of feed paths.

6. The image forming apparatus according to claim 1, further comprising an option unit removably attached to a recording sheet output side of an image forming apparatus body, wherein the second switchback feed path is accommodated in the option unit.
